(19) United States
(12) Patent Application Publication
(10) Pub. No.: US 2010/0281409 A1
(43) Pub. Date: Nov. 4, 2010

(54) APPARATUS AND METHOD FOR HANDLING NOTIFICATIONS WITHIN A COMMUNICATIONS DEVICE

(75) Inventors: Roope Rainisto, Helsinki (FI); Martin Schuele, Tampere (FI); Mox Soini, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/432,977

(22) Filed: Apr. 30, 2009

(51) Int. Cl. G06F 3/048

(52) U.S. Cl. 715/767; 715/846

(57) ABSTRACT

A notification manager for a computing device which has a display which designates a notification display area for simultaneously displaying a plurality of notifications when said notification manager is in a foreground mode, said notification display area being hidden when said notification manager is in a background mode, wherein a temporary notification is displayed when said notification manger is in said background mode, said temporary notification being displayed on a portion of a display not reserved for the display of notifications. The notifications in the notification area may be arranged according to an order in which they are generated. In an embodiment, notifications having an associated application are displayed in the notification display area and other notifications are displayed in a second area.

### TECHNICAL FIELD

Embodiments relate generally to computing devices and, more particularly, to handling notifications within a computing device.

### BACKGROUND

Multi-tasking operating systems allow computing devices to simultaneously run a number of applications. However, only one of these applications is in the foreground at any one time when, typically the output generated by that application is displayed and the application accepts input from a user. When one application is in the foreground, the remaining applications remain active, but in the background. An application can therefore be said to be in a foreground mode or a background mode.

When an application is in the background mode, an event may occur which that application handles, the occurrence of which should be communicated to the user. However, as that application is in the background a user is unaware of the occurrence of the event. Therefore, computing devices utilise notifications to inform a user of the occurrence of an event which they would not otherwise be aware of.

Furthermore, the concepts of background and foreground modes generally apply to user applications (i.e. those applications a user has control of in that the user is able to start and terminate the application). Other applications in computing devices operate exclusively in the background in the sense that a user may never be aware that the application is operational until the application causes a notification to be issued.

As computing devices increase in complexity, storage capacity and processing power, the number of notifications received also increases. Dealing with too many notifications can make for an unpleasant user experience unless the display of the notifications are managed.

### SUMMARY OF EMBODIMENTS

An embodiment provides an apparatus comprising a notification manager and a display, said notification manager being configured to:

designate a notification display area for simultaneously displaying a plurality of notifications on said display,

in a foreground mode display said notification display area and in a background mode hide said notification display area, and

display a notification temporarily on a portion of said display when in said background mode, said portion of said display not being reserved for the display of notifications during operation of said display.

A further embodiment provides a method comprising having a notification manager configure a notification display area to simultaneously display a plurality of notifications on a display, displaying said notification display area on said display when said notification manager is in a foreground mode, not displaying said notification display area on said display when said notification manager is in a background mode, said method further comprising displaying a notification temporarily on a portion of said display when said notification manager is in said background mode, said portion of said display not being reserved for the display of notifications during operation of said display.

A further embodiment provides a memory medium storing a computer program executable by a processor of a computing device, said computing device having a notification manager and a display, said computer program performing operations when executed by said processor, said operations comprising:

having a notification manager configure a notification display area to simultaneously display a plurality of notifications on a display,

displaying said notification display area on said display when said notification manager is in a foreground mode,

not displaying said notification display area on said display when said notification manager is in a background mode,

said operations further comprising displaying a notification temporarily on a portion of said display when said notification manager is in said background mode, said portion of said display not being reserved for the display of notifications during operation of said display.

By utilising a portion of the display not reserved for the display of notifications during operation of the display, embodiments are able to make more efficient use of the display. In particular, the portion of the display which may have been reserved for the display of notifications may instead now be used to display the output of user applications or a home view. This increases the size of the display available to such applications.

Furthermore, by providing a notification display area where notifications are displayed which is visible when the notification manager is in a foreground mode provides a dedicated area for displaying notifications which the user may display when desired.

### BRIEF DESCRIPTION OF THE DRAWINGS

Embodiments are hereinafter described with reference to the accompanying diagrams where like numerals are used to refer to like components and where:

FIG. 1 is a schematic representation of a mobile computing device wherein embodiments are implemented;

FIG. 2 is a schematic diagram illustrating the arrangement of hardware components of the computing device of FIG. 1;

FIG. 3 is a schematic diagram illustrating the arrangement of hardware and software components of the computing device of FIG. 1 when arranged according to an embodiment;

FIG. 4 is a further schematic representation of the mobile computing device of FIG. 3;

FIGS. 5 to 8, are notification manager views according to an embodiment;

FIG. 9 is a flow diagram illustrating the operation of the embodiment of FIGS. 5 to 8.

FIG. 10 is a further notification manager view according to an embodiment;

FIG. 11 is a flow diagram illustrating the operation of the embodiment of FIG. 10;

FIG. 12 is a further notification manager view according to an embodiment;

FIG. 13 is a flow diagram illustrating the operation of the embodiment of FIG. 12; and

FIG. 14 is a further notification manager view according to an embodiment.

### DESCRIPTION OF EMBODIMENTS

A description of a number of embodiments follows, provided by way of example only.

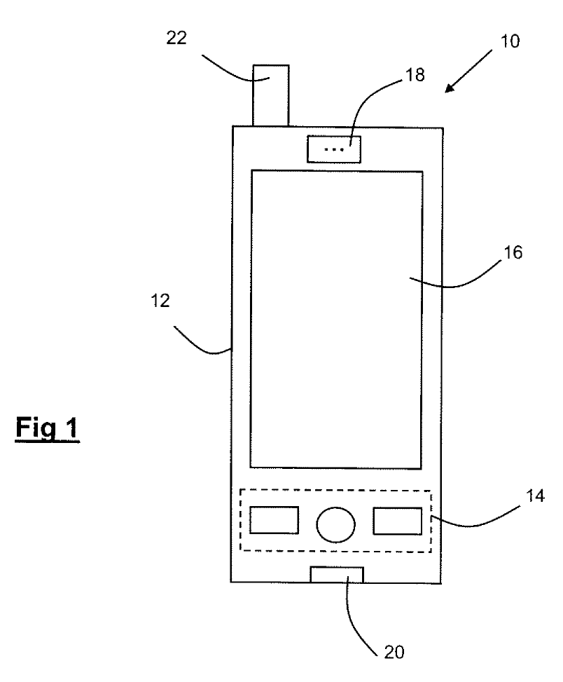

FIG. 1 is a schematic diagram of a computing device 10 having a casing 12. The computing device 10 forms the basis of the embodiments to be described. The casing 12 of the device 10 encapsulates a keypad 14, a touch-screen display 16, a speaker 18 and a microphone 20. The device 10 further includes an antenna 22. The device 10 illustrated in FIG. 1 is a mobile device in that it may be held in a user's hand and used to participate in communication sessions, in particular, telephone calls. During such sessions the device 10 may be utilised so that the speaker 18 is held to a user's ear and the microphone 20 is situated in proximity to a user's mouth.

The device 10 is a computing device which operates as a mobile phone. However, further embodiments relate to other computing devices which do not include telephony as their major function.

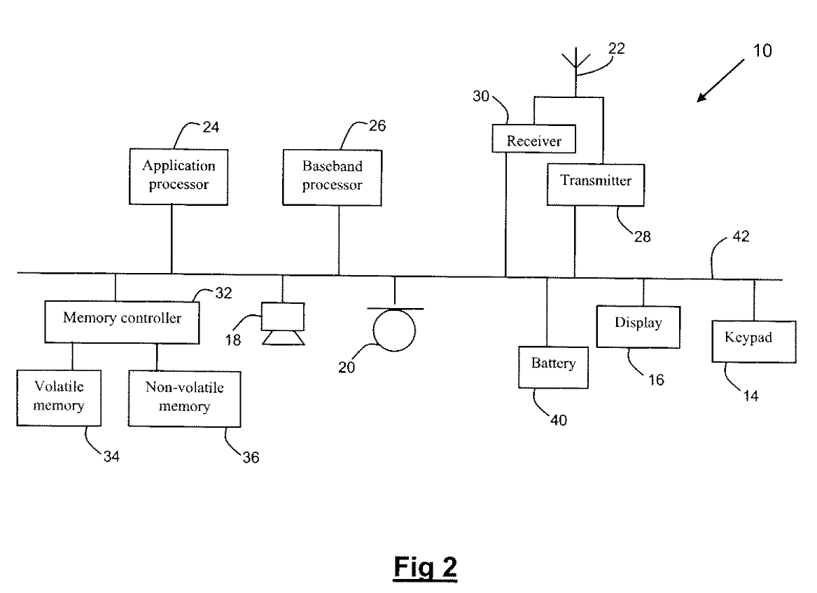

FIG. 2 is a schematic illustration showing the arrangement of the hardware components of the device 10 of FIG. 1. The keypad 14, display 16, speaker 18 and microphone 20 shown in FIG. 1 are connected to a system bus 42. The bus 42 is further connected to an application processor 24, a baseband processor 26, a transmitter 28, a receiver 30 and a battery 40. Transmitter 28 and receiver 30 are connected to the antenna 22. The bus 42 is further connected to a memory controller 32 which is, in turn, connected to volatile memory 34 and non-volatile memory 36. The application processor 24 processes instructions related to various software modules and operating system software which run on the device 10 and which provide various functionality of the device 10. The baseband processor 26 is concerned with the communication functions and to this end controls a telephony stack and communicates with the transmitter 28 and receiver 30 to establish communications by means of the antenna 22. The various processing elements of the device 10 such as the application processor 24 and baseband processor 26 may be provided on a single processor.

Memory controller 32 controls the access to, and interaction with, volatile memory 34 and non-volatile memory 36. In this manner the application processor 24 is able to communicate with the various hardware elements as well as the memory controller 32 and thereby control the operation of the various hardware elements according to software instructions stored on volatile memory 34 or non-volatile memory 36.

Only a single bus, bus 42, is illustrated in FIG. 2. It is to be realised that this bus may be replaced by two or more buses and that the topology of FIG. 2 would vary accordingly. Furthermore, known computing devices include hardware components additional to those illustrated in FIG. 2, but these are well known in the art and are not further described herein.

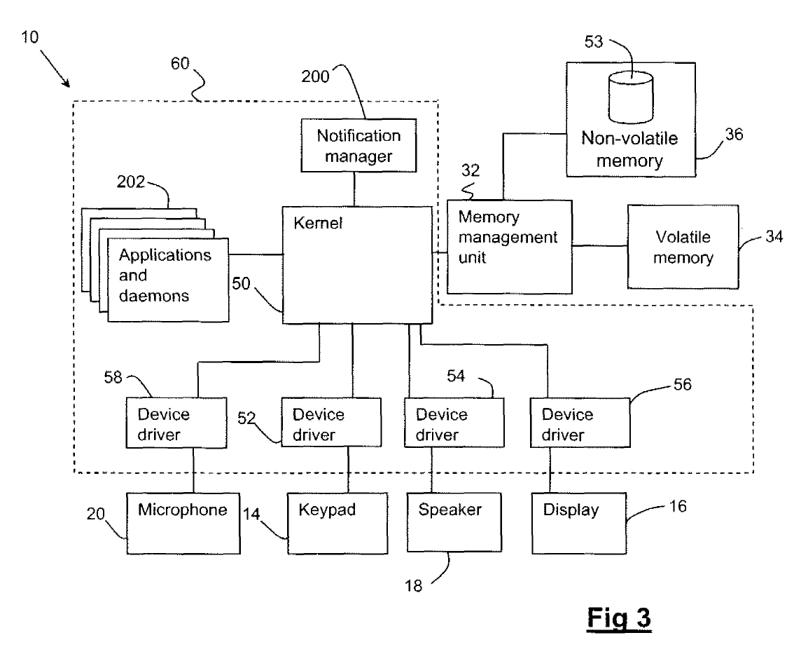

FIG. 3 is a diagram illustrating various hardware and software components of the device 10. The software operating on the device 10 can be categorised in various ways. Certain software operates to manage the resources provided by the various hardware components and to establish an operational environment in which other software executes. This software is known as the operating system of the device and is represented in FIG. 3 by a kernel 50. The kernel interacts with the memory management unit 32 which, as previously described, is connected to volatile memory 34 and non-volatile memory 36. The kernel 50 is further connected to a plurality of applications and daemons 44 each of which may access the hardware components in a manner dictated by the kernel 50. The applications 44 are user applications, which may be started and terminated by the user as well as system applications which are operated under the control of the kernel and which the user is not necessarily aware of. The kernel 50 is a multi-tasking operating system capable of running more than one user application simultaneously. When more than a single user application is running, only one of these may be in the foreground and the others are then in the background. The foreground application generally has more processing cycles from application processor 24 assigned to it, accepts input from a user and displays its output on the display 16.

System applications always run in the background in that the user is only aware that these applications are running when they notify the user of the occurrence of an event. Generally, such system applications do not accept input directly from a user. System applications are well known in the art and perform a number of functions such as keep track of hardware states such as the battery charge level, the state of removable memory or networking hardware. System applications are also referred to as ‘daemons’.

Both user and system applications may monitor and react to events occurring which these applications may be aware of. Therefore, an email application, being a user application, may continuously monitor an inbox and register the arrival of a new email as an event. Similarly a chat application may register a new message from one of the participants of the chat as a new event. System applications may also react to events such as the change of state of a hardware resource or the availability of software updates. These events may originate from a change internal to the computing device or from a change outside of the external device.

Both user and system applications may react to the occurrence events by generating a notification. A notification comprises a message to inform the user of the occurrence of the event. Therefore, notifications are generally associated with a particular application.

The kernel 50 is further connected to a notification manager 200 for helping a user of the device 10 keep track of notifications. The device 10 further comprises a notification manager database 53 stored in non-volatile memory 36. The notification manager 51 interacts with the notification manager database 53 by means of the kernel 50 and the memory controller 32 in the manner described below. Notifications are generated by the applications 44, passed to the kernel 50 which then passes them on to the user interface manager 51.

The kernel 50 is further connected to the keypad 14 by means of device driver 52, to speaker 18 by means of device driver 54 and to the display 16 by means of device driver 56. Only some of the hardware components have been illustrated but, generally, the kernel 50 controls the hardware resources of the device 10 through various device drivers. Furthermore, although the device drivers have been illustrated as separate to the kernel 50, it is possible for them to be incorporated into the kernel 50.

The software components of FIG. 3 are delineated by dashed area 60. However, this distinction between software and hardware is not essential. Components depicted as software in FIG. 3 may be rendered in hardware, and those depicted as hardware may, in certain circumstances, be rendered as software.

During operation of the device, software instructions stored in non-volatile memory 36 establish the kernel 50, the applications 44 and the device drivers 52, 54 and 56. Through the use of the various components illustrated in FIG. 3 a user is able to utilise the device 10 according to the functionality provided by the various applications 44. For example, a user uses the keypad 14 and/or the touch-screen display 16 to communicate with the kernel 50 by means of device drivers 52 and 56 to cause one of the applications 44 to access data stored on non-volatile memory 36 by means of memory management unit 32. The kernel 50 causes the data supplied by memory management unit 32, together with instructions supplied by the application, to be sent to the application processor 24 (FIG. 2). The application processor 24 will return results from the data and instructions, generally utilising volatile memory 34 in the process, and these will be returned to the application by the kernel 50. On further instructions from the application, the kernel 50 will cause the results to be displayed to the user on display 16 by means of device driver 56. It is to be realised that device drivers 52, 54 and 56 are also software components originating from instructions stored on non-volatile memory 36.

The illustration of FIG. 3 is presented merely by way of example; known devices may comprise more components than those shown. Implementations of embodiments are not dependent on the precise arrangement and configuration of components shown in FIGS. 1, 2 and 3. Therefore other components with similar functionality may be substituted and further components added thereto, or illustrated components omitted therefrom, without affecting the operation of embodiments.

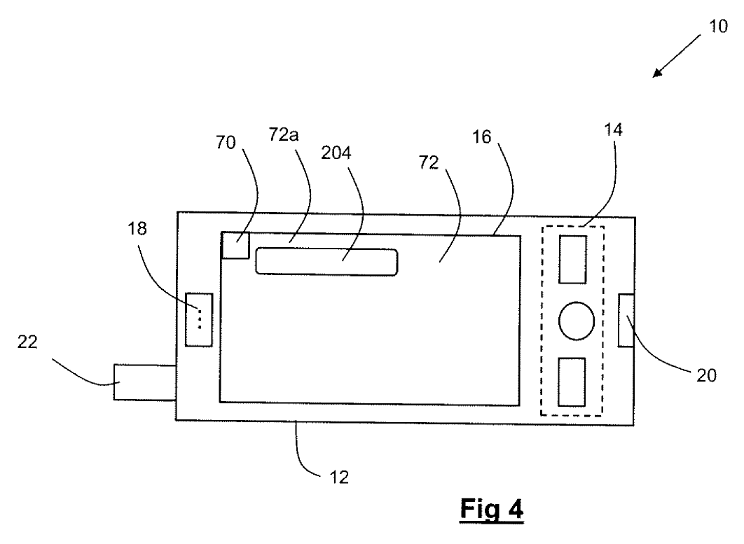

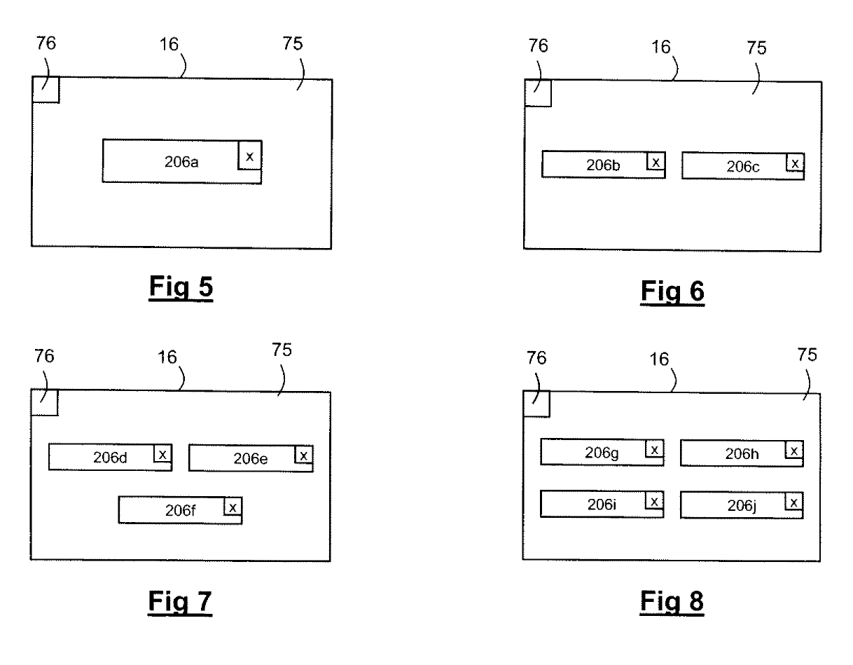

FIG. 4 shows the device 10 of FIG. 1 rotated anti-clockwise through 90 degrees, so that the display 16 is in a landscape orientation. In this orientation, a top-left portion of the display 16 is configured as a button 70. A remaining portion 72 of the display 16 which does not comprise the button 70 provides a conventional display means for the device 10. For example, the remaining portion 72 could display a running use application or a desktop (also known as a ‘home view’). The button 70 is linked with the notification manager 200 (FIG. 3) and provides a user with a means for launching a user interface provided as a notification manager view (FIGS. 5 to 8).

FIG. 4 also shows a notification preview 204 on the remaining portion 72 of the display 16 in a top-left region. The notification preview 204 provides a temporary preview of a new notification. More specifically, when a notification is first received or first generated, the notification manager 200 generates a notification preview 204 on the remaining portion 72 of the display 16 in the manner described below. The preview 204 is a temporary message informing the user of the new notification and providing some detail of the notification event. For example, if a new email is received, a notification preview will appear on the display 16 in the position indicated on FIG. 4 and contain the text ‘NEW EMAIL’. The preview 204 will remain on the remaining portion 72 of the display 16 for a short period of time and will remain in front of whatever is currently displayed on the remaining portion 72 of the display 16, such as, for example, the home view or an application view. Therefore, the preview 204 is displayed on a portion of the display 16 which is reserved for the display of notifications, but on a portion which is used for the display of the output of user applications.

In this embodiment, the preview remains for five seconds, after which it fades away. In an alternative embodiment, the preview remains for ten seconds. Importantly, the time period for which the temporary notification preview is visible should be sufficient that the preview is visible to the user, but not so long as to unnecessarily interfere with the user's use of the device 10 (considering that the preview appears in a portion of the display which the user may be using for a particular application).

As illustrated in FIG. 4, the preview 204 is orientated so that it is offset from a periphery of the display 16. Therefore, a part 72a of the remaining portion of the display 72 is visible between the preview 204 and the closest periphery of the display 16. This helps to ensure that the preview is positioned so that it is visible to the user and attracts the user's attention.

The button 70 is linked with the notification manager 200 (FIG. 3) and provides a user with a means for activating a user interface comprising a notification manager view 75 (FIGS. 5 to 8, discussed below). The notification manager view is a notification display area designated by the notification manager 200 where notifications are simultaneously displayed in the manner described below. As any other user application, the notification manager 200 may operate in the foreground or in the background. Button 70 is displayed when the notification manager 200 is in the background and, on user interaction with the button 70, the notification manager is brought to the foreground. In this respect, the notification manager 200 differs from other user applications in that it accepts user interaction when a background mode.

FIGS. 5 to 8 provide screen shots of the display 16 of the user interface showing the notification manager view 75, according to an embodiment. On activation of the button 70 by suitable means, such as, for example, a user's finger or a stylus, the notification manager view 75 is displayed. Activation of button 76 switches the notification manager from a background mode, wherein the notification manager view 75 is not visible on the display 16, to a foreground mode, wherein the notification manager view 75is displayed on the display 16.

In the present embodiment, when the notification manager view is in the foreground mode (as shown in FIGS. 5 to 8) the notification manager view 75 occupies substantially all of the display 16.

The notification manager 200 displays notifications on the notification manager view 75 in the form of icons 206a to 206j. Each icon relates to at least one notification and contains information relating to the notifications. For example, an icon for a notification relating to a new email event may include the text ‘NEW EMAIL’ and additionally may include the email subject and sender. Moreover, in the present embodiment, the icon may relate to more than one event. Under the aforementioned example if two email messages were received, instead of displaying the ‘NEW EMAIL’ message twice, a single icon with the message ‘2 NEW EMAILS’ is displayed. In any case, the principle of the icon is to enable a user of the device 10 to instantly identify the event which it related to and to relay the information of the notification(s) to the user.

In the present embodiment, the size of the notification manager view 75 is independent of the number of icons displayed thereon. Furthermore, the size of the notification view 75 does not change. Advantageously, this renders the layout of notifications in the area delimited by the view 75 relatively straightforward as changes in the size of the area need not be taken account of.

Further, each of the icons 206a to 206j contains a top-right portion marked with the symbol ‘x’. The portion of each icon marked ‘x’ provides a button which the user may use to remove the notification from the notification manager view 75. Furthermore, the notification manager views 75 of FIGS. 5 to 8 each contain a button or icon 76 positioned in a top-left portion. The button 76 takes the place of the button 70 when the notification manager 200 is in the foreground mode. Also, the button 76 enables the user to move the notification manager 200 from the foreground mode back to the background mode, wherein the button 70 takes the place of the button 76.

Advantageously, the notification display area may therefore be shown or hidden by a single button press (either button 70 or button 76).

The icons 206a to 206j are laid out in accordance with layout rules. The layout rules are stored and implemented by the notification manager 200. Firstly, the layout rules ensure that all icons are positioned clearly on the notification manager view. Secondly, the layout rules may ensure that each icon is sized to make efficient use of the space available on the notification manager view, and thereby make it easy for the user to identify which event is being represented by each icon.

In the present embodiment, the position and size of each icon is dependent on the number of icons displayed. It is within the scope of further embodiments however, that the position and not the size of each icon is dependent on the number of icons displayed. In these further embodiments, the size of the icons remains constant, irrespective of the number of icons displayed in the notification display area 80.

The following explains the implementation of the layout rules to generate FIGS. 5 to 8. FIG. 5 represents a case where there is only one notification, wherein icon 206a represents the notification. Icon 206a is sized larger than the icons of FIGS. 6 to 8, and is positioned in the centre of the notification manager view. FIG. 6 represents a case where there are two notifications (a second notification has occurred), wherein icons 206b and 206c represent the two notifications. FIG. 7 represents a case where there are three notifications, wherein icons 206d to 206f represent the three notifications. Finally, FIG. 8 represents a case where there are four notifications, wherein icons 206g to 206j represent the four running applications. In the present embodiment, there is a predetermined maximum number of icons which can be displayed on the notification manager view. In the present embodiment, the maximum number is four, as illustrated in FIG. 8. As FIGS. 5 to 8 illustrated the notification manager view 75 as progressive notifications are processed, it is to be realised that icons 206a, 206b, 206d and 206g represent the same notification in different arrangements.

Furthermore, as illustrated in FIGS. 5 to 8, there are certain layout rules which govern the display of notification and the layout rules depend on the number of notifications received. If there are an even or square number of notifications to be simultaneously displayed, then these are layed out in a grid pattern. A single notification (FIG. 5) is centred in the task manager view 75. No more than two notifications are displayed in the same row and each row is vertically centred.

It is also important to note that that the icons displayed on the notification manager view 75 are ordered in a sequence corresponding to the order in which the notifications are received or generated. For example, consider the situation in which the device 10 receives or generates the following notifications in the following order, a new email message, a new SMS message and a low battery notification. If the user then activates the button 70 from the home view or an application view, the layout of the applications would correspond with FIG. 7, where three icons are shown. Moreover, the order of the icons would correspond to the order in which the three notifications were received or generated. Therefore, the icon 206d would here represent the new email, the icon 206e would represent the new SMS message and the icon 206f would represent the low battery notification. An advantage of operating in this way is that it makes it easier for the user to identify notifications using the corresponding icon. If an icon's location is subject to change, the user would have to identify the location of each icon each time the notification manager 200 was brought to the foreground. This would waste the user's time and lead to a worse user experience. The only exception to this operation is when an icon is closed. In this case, the positions of the remaining icons are adjusted in line with the above-mentioned layout rules, but their relative positions remain the same (i.e. the positions of the remaining icons is dependent on the order in which the corresponding notifications are received).

When the user actives the button 70 to move the notification manager 200 from the background mode to the foreground mode, one or a number of icons are displayed in dependence on which notifications have been received or generated before that time.

Furthermore, notifications may be cleared. This generally occurs if, during the course of subsequently operating the device 10, the user views the events relating to those notifications (by, for example, viewing the application to which the notification relates). The manner in which a notification may be cleared will depend on the notification concerned. Some notifications will clear automatically after a predetermined time whereas others require user interaction. In any event, when the user actives the button 70 (either from an application view or the home view) the icons which have been cleared will not be displayed on the notification manager view. In a further embodiment, any notifications which have not been cleared by a user after a predetermined time are automatically cleared.

In order to track the notifications, the notification manager 200 maintains the notification database 53 with entries for notifications which are running on the device 10. More specifically, each time a notification is received or generated, the notification manager 200 adds a corresponding entry to the database 53. Further, each time a notification is cleared by the user, the notification manager 200 removes the corresponding entry from the database. Then, when the user selects button 70 to bring the notification manager view to the foreground, the notification manager 200 loads an icon only for those applications which have a corresponding entry in the database. According to this operation, the notification manager 200 is capable of accurately keeping up to date with which notifications are still relevant to the user.

In addition to the notification manager view providing means for the user to identify, at any chosen time, which new events have occurred, the notification manager view also allows the user to handle those events. More specifically, on FIGS. 5 to 8, each of the icons 206a to 206j may be selected by suitable means, such as, for example, a user's finger or a stylus, to launch the application corresponding to that notification (i.e. to start running the application) or to bring that application to the foreground.

For example, while using the device 10 to browse the internet the device 10 may receive a new email. According to the above described operation, a preview of the notification will first temporarily be displayed on the browser applications view (as described above with reference to FIG. 4). At some later time the user may select button 70 (e.g. from the browser's view or the home view) to bring the notification manager 200 into foreground mode. An icon displayed on the notification manager view will correspond to the new email event. According to this embodiment, the user may select the corresponding icon (for example, by tapping on the icon) to launch the email application on the display 16 and view the new email. Alternatively, if the email application is already running in the background, the notification manager 200 will move the email application to the foreground rather than launch it for a second time.

In order to maximise the display area of the notification manager view 75, the notification manager 200 can group together notifications relating to similar events. For example, two new emails are received by the device 10 while the user is using the device 10 to browse the internet. Each time a new email is received a preview 204 relating to that email will be temporarily displayed on the browser's application view. If the user activates the button 70 from the browser's view to launch the notification manager view, only a single icon represents both new emails. However, the text of the icon indicates that the icon relates to two notifications which have been grouped together, for example, the text reads ‘2 NEW EMAILS’ rather than ‘NEW EMAIL’. According to this operation, the notification manager 200 is able to preserve the space available on the display area of the notification manager view and thereby notify the user of more events.

According to the present embodiment, when the display 16 contains the notification manager view 75, i.e. the notification manager view is in the foreground mode, notification previews 204 are not displayed. Instead, a new notification icon is displayed on the notification manager view as soon as the new notification is received or generated. However, some further embodiments do display notification previews 204 on the notification manager view.

According to the present embodiment, when a notification preview 204 fades away, the button 70 changes to indicate to the user that a new notification has been received or generated and can be viewed on the notification manager view. By operating in this way the button 70 acts as a prompt to make it known to the user that a new notification can be viewed on the notification manager view 75. The button 70 may prompt the user by flashing or by changing colour. As the button 70 only appears when the notification manager view is in the background mode, the prompt associated with the button 70 occurs when the notification manager view is in the background view.

According to the present embodiment, if the user selects a notification preview 204 when it is displayed on the home view or an application view, the notification manager 200 instructs the kernel 50 to launch the application which handles or is associated with the event which the notification preview relates to, or bring that application to the foreground. For example, if the notification preview relates to a new email message, then if the user selects the preview, via suitable selecting means, such as a finger or a stylus, the email application is launched or brought to the foreground. In this case, as the notification will have been seen by the user before the notification manager 200 has an opportunity to display an icon relating to the notification on the notification manager view, no such icon will appear the next time the user views the notification manager view.

According to the present embodiment, the first time that the user views a notification via the notification manager view, that notification is highlighted to indicate to the user that they have not seen the notification in the notification manager view before (the user may, or may not, have seen the corresponding, temporary notification preview). For example, the icon relating to an unseen notification may flash or change colour. If the user chooses to ignore the notification and activate button 76 to move the notification manager 200 to the background mode, the next time the user activates the button 70 to move the notification manager 200 to the foreground view the notification will no longer be highlighted. For example, the icon will no longer flash or the colour will revert back. The advantage of operating in this way is that the user can instantly see when entering the notification manager view which events have not been seen before in this view. Accordingly, the user does not waste time looking at old notifications.

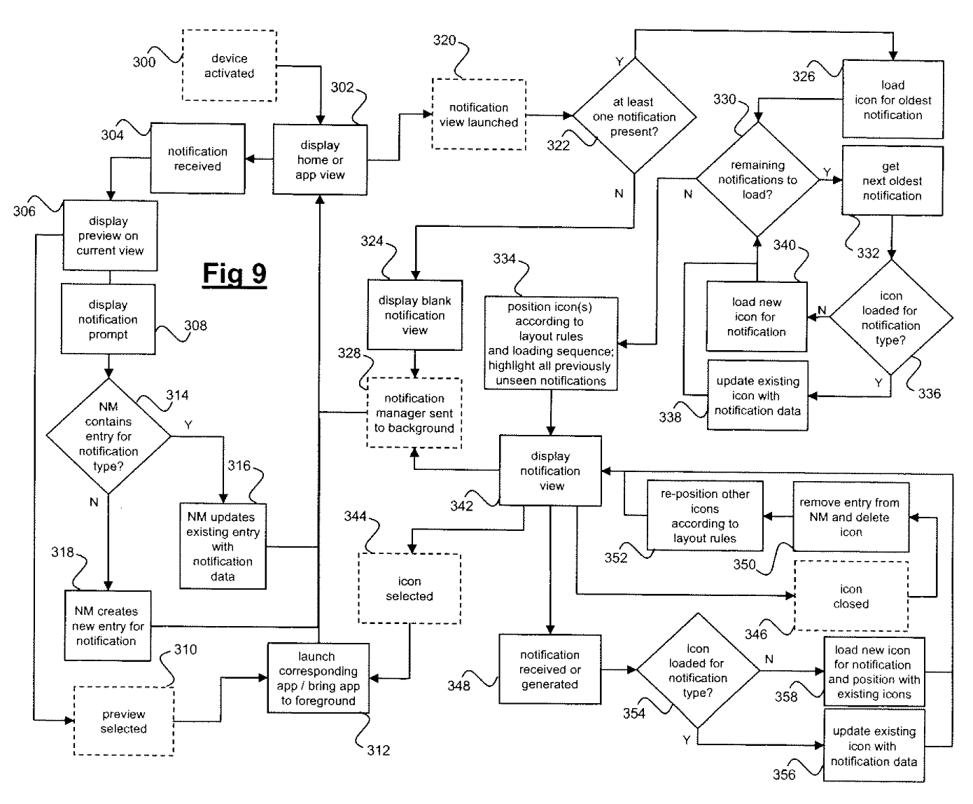

FIG. 9 provides a flow diagram of the operation of an embodiment. It is noted that within FIG. 9, there are three different styles of step. Rectangular-shaped steps with a continuous boarder indicate processing performed automatically by the device 10. Rectangular-shaped steps with a dashed border indicate processing performed as a result of an input received from a user, such as, for example, an interaction between a stylus and the touch screen display 16. Diamond-shaped steps indicate a binary question, wherein the alternative answers to the question are indicated by the letters ‘Y’ and ‘N’ on flow paths leaving the step.

Operation according to FIG. 9 begins at step 300. At step 300, a user of the device 10 turns it on and the device boots up. Once the device is ready for operation processing flows to step 302. At step 302, the device waits in a home view (also know as a desktop). While in step 302, the user may also launch and operate one of the applications 44 such that the display 16 shows an application view. While in either the home view or an application view, if a notification is received by the notification manager 200, processing flows from step 302 to step 304. At step 304, the notification is received or generated, following which processing flows to step 306. At step 306, a notification preview 204 is displayed on the display 16, where the display 16 contains either the home view or an application view. The notification preview remains on the display 16 for a temporary period and then fades away. Once the notification preview has been displayed at step 306 processing flows to step 308 (discussed later), unless the user selects the preview, in which case processing flows to step 310.

If the user does not select the preview, processing flows from step 310 to step 312, wherein the notification manager 200 instructs the kernel 50 to launch the application to which the notification preview relates. It is to be realised that only notifications relating to user applications will have applications associated therewith and if the user selects this type of notification, the corresponding application will be launched. For example, if the notification preview relates to a new email message which has been received, if the user selects the preview, using suitable selection means, such as a finger or a stylus, the email applications is launched. However, if the email program is already running in the background then the device moves the application to a foreground mode rather than re-launching it. Other notifications, such as system notifications may have a user application associated therewith and this user application will be launched or brought to the foreground on selection by the user. Other notifications may however have no application associated therewith and in this instance, selection of the notification will not generate a result and the process here will return to step 302.

Once the application corresponding to the notification has been started, processing flows back to step 302, wherein the application view is displayed.

As mentioned briefly above, if at step 306 the user does not select the preview, processing flows to step 308 and the preview will disappear after a predetermined time (here five seconds). At step 308, the notification manager 200 displays a prompt to the user on the home view or application view to indicate to the user that there are new notifications displayed on the notification manager view 75. As mentioned above, a suitable prompt may be the button 70 flashing or changing colour. In the current embodiment, the prompt is only displayed for the first notification received while the notification manager 200 is in a background mode. Therefore, at step 308, the notification manager will determine if the prompt is already displayed and whether the notification manager 200 is in a background mode. If either of these apply, the prompt will not be displayed at step 308.

Once the prompt has been activated, processing flows to step 314. At step 314, the notification manager 200 identifies if it has an entry in its database 53 for the type of notification received at step 304. For example, if the received notification relates to a new email message, at step 314, the notification manager 200 identifies if it already has an entry in its database 53 relating to a new email. If the notification manager 200 does contain an entry for the type of notification received at step 304, processing flows to step 316, otherwise processing flows to step 318. At step 316, the notification manager 200 updates the existing entry in its database with the data of the new notification. Alternatively, at step 318, the notification manager 200 creates a new entry in the database 53 for the new notification. In either case, processing flows back to step 302, discussed above.

According to the above operation, the notification manager 200 is capable of keeping up to date with notifications as they are received by the notification manager 200. In particular, all new notifications will have a corresponding entry in the notification manager's database 53 until the icon corresponding to the notification has been seen by the user.

While waiting at step 302, the user may instruct the notification manager 200 to display the notification manager view by pressing the button 70 on either the home view or an application view. This operation is indicated on the flow diagram by step 320. Once the button 70 has been activated processing flows from step 320 to 322. At step 322, the notification manager 200 identifies if at least one notification is present. In this embodiment, the notification manager 200 inspects the database 53 to identify whether any entries are present. If no entries are present in the database, processing flows to step 324, otherwise processing flows to step 326, discussed below. At step 324, the notification manager 200 displays a blank notification manager view. More specifically, the user interface displayed comprises a button 76 (FIGS. 5 to 8) but no icons. The only operation available to the user in this situation is to select button 76 to return the notification manager 200 to the background (step 328). Processing then flows back to step 302.

As mentioned above, if at step 322 the notification manager 200 identifies that at least one entry exists in its database 53, processing flows to step 326. At step 326, the notification manager loads an icon for the oldest entry. The oldest entry corresponds to the oldest notification icon not seen by the user in the notification manager view 75. The process of loading the icon may involve retrieving relevant data from the notification. For example, if the notification relates to a new email message, retrieved data may comprise the email subject and/or the email sender. The data will depend on the type of notification concerned.

Once the icon has been loaded, processing flows from step 326 to step 330. At step 330, the notification manager 200 identifies if there are any remaining entries in the database 53. Stated differently, the notification manager identifies if there are any other notifications for which an icon must be loaded. If there are other notifications then processing flows to step 332, otherwise processing flows to step 334, which will be discussed later.

At step 332, the notification manager 200 obtains the next oldest entry from the database, following which processing flows to step 336. At step 336, the notification manager 200 identifies whether an icon has already been loaded for the type of notification relating to the currently processed notification. If an icon has already been loaded for this type of notification then processing flows to step 338, otherwise processing flows to step 340. At step 338, the pre-existing notification of a similar type is updated to contain information relating to the currently processed notification. At step 340, a new icon is created for the new notification. For example, if the oldest and next oldest entry both relate to new email messages, an email notification will be loaded at step 326 and this notification will be updated at step 338 to reflect the receipt of a second email. Alternatively, if the next oldest entry relates to a new SMS message, an email notification will be loaded at step 326 and an SMS notification will be loaded at step 338. In either case, processing from both steps 338 and 340 flows to step 330, discussed above.

As briefly mentioned above, if at step 330, an icon has been loaded for all entries in the notification manager's database 53, processing flows to step 334. At step 334, the notification manager 200 positions all the loaded icons on the notification manager view according to the layout rules mentioned above and ensures that the order of the icons matches the order in which they were loaded. This order also matches the order in which the corresponding notifications were first received. Once the icons have been positioned in step 334, processing flows to step 342. At step 342, the notification manager 200 displays the notification manager view 75 comprising one or more icons and the button 76, as illustrated by FIGS. 5 to 8.

According to the above operation the user can select the button 70 from the home view or an application view to display a notification manager view comprising an icon for each notification which relates to an event not seen by the user.

From step 342, the operational flow can take one of four different paths. In particular, processing can flow to any one of the following steps 328, 344, 346 and 348. As identified by the step boarders, processing flows to steps 328, 344 and 346 as a result of an instruction from the user, whereas processing flows to step 348 as a result of a operation which is independent of the user. The following describes the four possible processing routes from step 342.

Firstly, processing flows to step 328 if the user selects the button 76 positioned at the top-left of the notification manager view 75. At step 328, the notification manager 200 moves the notification manager view to the background mode (thereby hiding the notification manager view 75) then processing flows back to step 302. At step 302, the display 16 displays the view which was previously displayed when the user selected the button 70 at step 320. This view will either be the home view or an application view.

Secondly, processing flows to step 344 if the user selects one of the icons from the notification manager view 75. The user can select an icon by selecting any part of the icon excluding the top right portion (i.e. the portion marked with an ‘x’ on FIGS. 5 to 8). Once the user has selected the icon, processing flows to step 312, where the application corresponding to the notification is launched or brought to the foreground. For example, if the user selects an icon from the notification manager view 75 which relates to a notification that a new email has been received, at step 312, the notification manager 200 instructs the kernel 50 to activate the email application. Processing from step 312 is discussed above.

Thirdly, processing flows from step 342 to step 346 if the user selects the top-right portion of an icon marked with symbol ‘x’ from the notification manager view 75 to close the icon. Once the user has selected the top-right portion of an icon, processing flows to step 350. At step 350, the notification manager 200 removes the corresponding entry from its database 53, and deletes the icon from the notification manager view. Processing then flows to step 352, wherein the notification manager 200 adjusts the positions of the remaining icons on the notification manager view 75, according to the layout rules discussed above. Processing then flows back to step 342, which is discussed above. A user may opt for the above-described operation if, for example, the notification manager 200 has provided an icon relating to an unwanted email or for any other notification in which the user is not interested.

Fourthly, processing flows to step 348 if the device 10 receives or generates a new notification. As mentioned above, if the notification manager view is in the foreground mode notification previews are not displayed. Stated differently, notification previews are displayed if the notification manager view is in the background mode. Therefore, once a new notification is received processing flows to step 354. At step 354, the notification manager 200 identifies whether an icon has already been loaded for the type of notification relating to the new notification. If an icon has already been loaded, processing flows to step 356, otherwise processing flows to step 358. At step 356, the pre-existing notification of a similar type is updated to include information relating to the new notification. At step 358, a new icon is loaded for the new notification and positioned on the notification manager view 75 according to the aforementioned layout rules. Also, the new notification is highlighted to indicate that the user has not seen it before. Processing then flows back to step 342, which is discussed above.

According to this operation, the user is able to use the notification manager 200 to identify new and unseen events at any chosen time. Additionally, the notification manager 200 provides a means for the user to quickly access the application relating to a new or unseen event. Additionally, the notification manager 200 provides a means for the user to ignore particular events without launching its corresponding application or having that application in the foreground. Additionally, the notification manager 200 shows a preview of a new notification and a prompt indicating to the user that new notifications are present. It is an advantage of this embodiment that the user can quickly and effectively manage incoming and internal events from one predetermined display area. Additionally, it is an advantage that because the order of the icons does not change the user can quickly identify the location of the corresponding icon for a particular event. Additionally, it is an advantage that the user can quickly identify which icons have not been seen before, as they are highlighted.

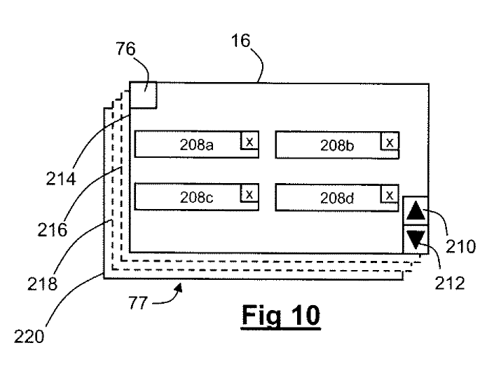

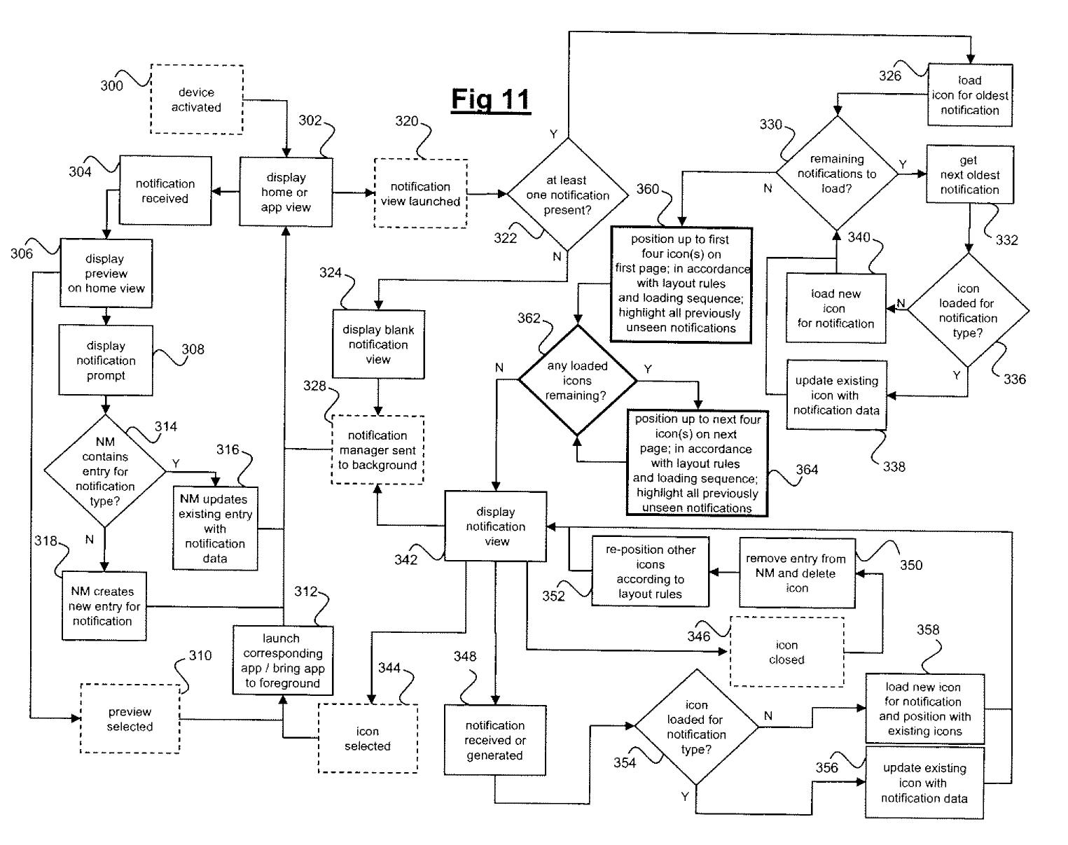

FIGS. 10 and 11 provide an exemplary screen shot and flow diagram according to another embodiment. FIG. 10 illustrates a notification manager view 77 in multi-page format. In particular, when more than four notifications are present the notification manager view spans across a number of different pages, wherein each page comprises no more than a maximum number of active icons (in this embodiment, four). This is illustrated in FIG. 10, wherein a notification manager view 77 is shown in multi-page format. In FIG. 10, four notification manager view pages are shown, 214, 216, 218 and 220. Four icons 208a to 208d are displayed on the first page 214.

Buttons 210 and 212 are displayed in the bottom-right corner of the notification manager view. The up button 210 enables the user to cycle through the different notification manager view pages. Down button 212 enables the user to cycle through the different notification manager view pages (214, 216, 218 and 220) in the opposite direction to button 210. The number of notification manager view pages is dependent on the number of running applications. Although the notification manager view of FIG. 10 is shown with four pages, it is to be realised that the pages are created as they are required and that this is determined by the number of icons to be displayed on the notification manager view 77.

FIG. 11 provides a flow diagram of how the multi-page format notification manager view is generated by the present embodiment. The following describes the aspects of FIG. 11 which are different from FIG. 9. In particular, in FIG. 11, step 334 of FIG. 9 has been replaced by new steps 360, 362 and 364. Therefore, at step 330 and when all icons have been loaded, processing flows to step 360. At step 360, the notification manager 200 positions the first four loaded icons on the first page the notification manager view 77 according to the layout rules mentioned above and ensures that the order of the icons matches the order in which they were loaded. This operation ensures that the first page 214 contains the icons for the four oldest notifications. Processing then flows from step 360 to step 362. At step 362 the notification manager 200 establishes if there are any more loaded icons to be positioned. This will only be the case if there are more than four icons present. If there are more than four loaded icons then processing flows from step 362 to step 364, alternatively processing flows from step 362 to step 342, which is discussed above with reference to FIG. 9. If processing flows to step 364, the notification manager 200 positions the next four loaded icons on the next notification manager view page according to the layout rules mentioned above, ensures that the order of the icons matches the order in which they were loaded and highlights any new notifications. This operation ensures that the second page contains the icons for the fifth to eighth notifications received (assuming that each notification has a corresponding icon and that none of the notifications are grouped together). Processing then flows from step 364 back to step 362 and will continue to flow in a loop around these two steps so long as there are loaded icons which have not been positioned on a notification manager view page. Once all loaded icons have been positioned on a page, processing flows from step 362 to step 342, which is discussed above with reference to FIG. 9.

It is an advantage of this embodiment that many more than four icons may be displayed on the notification manager view 77. As before, the order of the icons does not change thereby enabling the user to quickly identify an icon. The only exception to this rule occurs when icons are deleted. In this case, remaining icons are moved to fill in the empty space, but the relative order of the remaining icons remains the same. Furthermore, this embodiment allows no more than the maximum number of icons (here four) to be displayed at any one time and this ensures that the size of the icons may be maintained above a certain minimum size (i.e. the size required to display four icons in the task manager view 77). This, in turn, helps to ensure that the message of the icons is legible to the user and that the task manager view does not become too cluttered with icons.

According to the present embodiment, when the button 70 is activated by the user, the notification manager view page which was last viewed by the user is the one to be brought into foreground mode. If the user has not viewed any page previously, the first page is loaded, which contains the first notifications to be received or generated. An advantage of this operation is that the user is able to locate the icon relating to a particular event more quickly and this leads to an improved user experience.

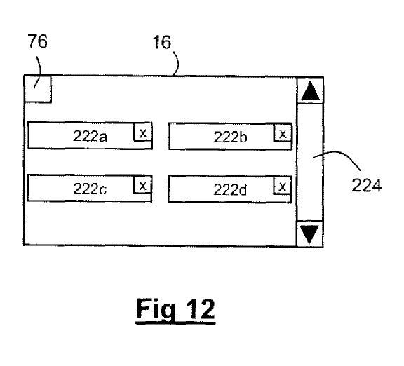

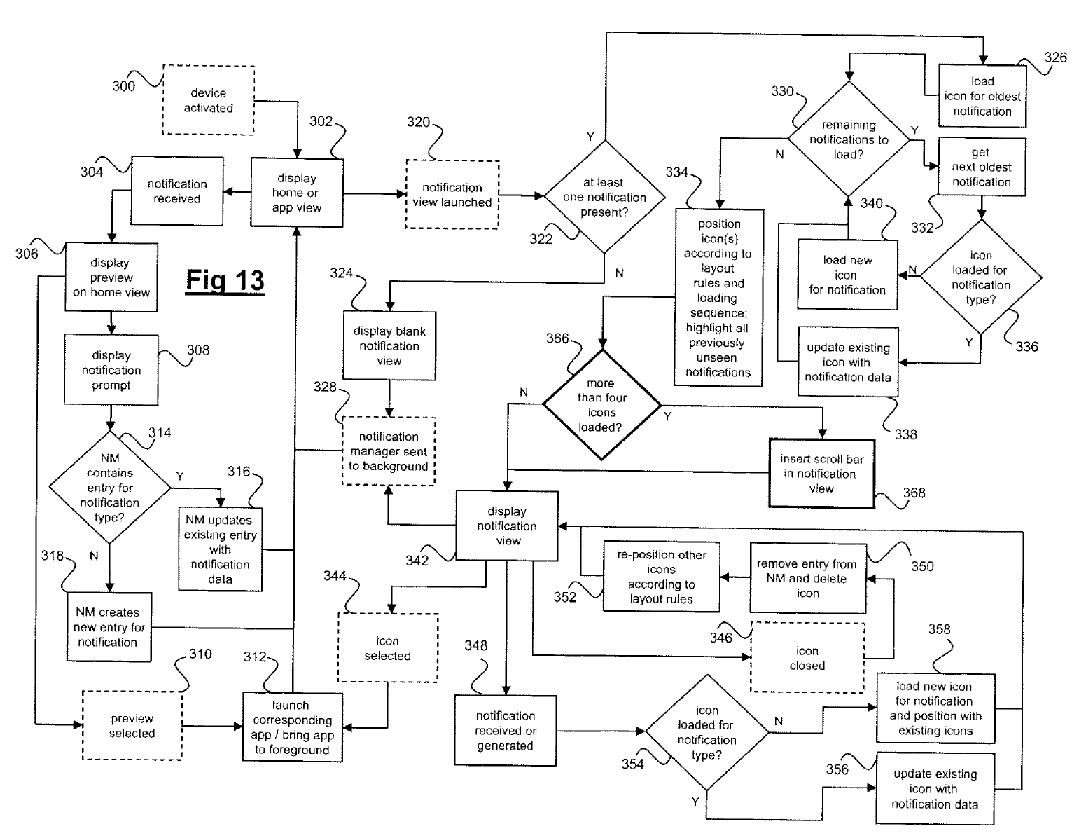

FIGS. 12 and 13 provide an exemplary screen shot and flow diagram according to another embodiment. FIG. 12 illustrates a notification manager view 79 in scroll-page format. In particular, when more than four applications are running the notification manager view 79 may increase in length to accommodate more than four icons. The user may navigate around the page using a scroll bar, as is well known in the art. This is illustrated on FIG. 12, wherein a notification manager view 79 is shown in scroll-page format. In particular, four icons are displayed 222a to 222d. Additionally, a scroll bar 224 is displayed along the right-hand edge of the notification manager view 79 for scrolling the notification manager view.

FIG. 13 provides a flow diagram of how the scroll-page format notification manager view is generated by the present embodiment. The following describes the aspects of FIG. 13 which are different from FIG. 9. In particular, in FIG. 13, new steps 366 and 368 have been added in between steps 334 and 342 of FIG. 9. Therefore, at step 334 and when all icons have been positioned, processing flows to step 366. At step 366, if more than four icons have been positioned processing flows to step 368, alternatively processing flows to step 342, which is discussed above with reference to FIG. 9. At step 368, the notification manager 200 inserts the scroll bar 224 in the notification manager view to enable the user to scroll the notification manager view and extends the notification manager view 79 appropirately. Processing then flows to step 342, which is discussed above with reference to FIG. 9.

It is an advantage of this embodiment that any number of icons may be displayed on the notification manager view. As before, the order of the icons does not change thereby enabling the user to quickly identify an icon. The only exception to this rule occurs when icons are deleted. In this case, remaining active icons are moved to fill in the empty space.

According to the present embodiment, when the button 70 is activated by the user, the portion of the notification manager view which was last viewed by the user is the portion to be brought into foreground mode. If the user has not viewed the notification manager view previously, the first portion is loaded, which contains the oldest notifications. An advantage of this operation is that the user is able to locate the icon relating to a particular event more quickly and this leads to an improved user experience.

In the embodiments discussed above, the notification manager 200 is configured to provide an icon on the notification manager view for each notification received or generated by the device 10. However, it is within the scope of some embodiments that the notification manager may suppress display of one or more selected notifications. Further, it is also possible that the notification manager is configured to select particular notifications according to user-specified criteria, system criteria, or according to the number, frequency or origin of those notifications. For example, consider the case of an instant messaging discussion between ten people. In such circumstances is the notification manager 200 may be configured to not provide notifications each time a discussion participant provides a new comment. Instead, the notification manager may only provide a notification when there has been a predetermined period of silence from all participants, such as, for example, ten minutes.

In a further example, system related notifications will only be displayed if they meet specified criteria. In this example, the system notifications are designated as either urgent or non-urgent and only the urgent notifications are displayed. In yet a further example, the user is able to specify which notifications are to be displayed. This may occur, for example, by allowing the user to specify which notifications are considered to be urgent, or allowing the user to specify applications, the notifications corresponding to which are always displayed or always hidden.

In the embodiments discussed above, the button 70 comprises a software button positioned in a top-left portion of the display 16 in a landscape orientation. It is within the scope of some embodiments that the button 70 could be positioned elsewhere on the display 16, such as, in a bottom-right portion. Furthermore, it is within the scope of some embodiments that the button 70 could be a hardware button, positioned within the keypad 14 or elsewhere on the device 10. Further still, such a hardware button could be provided by a pre-existing button or a new designated button.

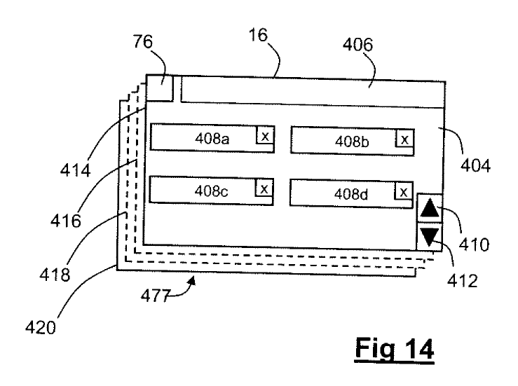

FIG. 14 illustrates a notification manager view 477 according to a further embodiment. In this embodiment, the notification manager view has four pages 414, 416, 418 and 420 and the pages are arranged and assigned in the manner described above with reference to FIG. 10. Furthermore, each page is divided up into two areas, area 404 and area 406. Area 404 operates in the same manner as the notification manager view 77 pages of FIG. 10, but only notifications relating to user programs are displayed in area 404. Area 406 is reserved for notifications which are not associated with a particular user application and are therefore merely provided as information to the user.

Generally, notifications which are associated with system applications or daemons will be displayed in area 404 and notifications which are associated with user applications are displayed in area 406. This is not always the case however. For example, in certain situations a notifications relating to a system application may have a user application associated therewith. For example, a system application will monitor the state of the battery 40 and a notification will be generated when the charge in the battery falls below a predetermined level. Although the resultant notification is generated by the system notification, in an embodiment, this notification is associated with a user application which the user may use to control various aspects of the computing device which affect the rate at which the battery charge is consumed.

Therefore, when the notification manager 200 processes notifications, it will determine whether each notification has an application associated therewith. If the notification does have an application associated therewith, the process will proceed as illustrated in FIG. 11 and as previously described. If the notification does not have an application associated there with, the notification will be displayed in area 406. In this latter instance no groupings of notification occurs and a subsequent notification displayed in this area will replace the preceding notification.

In a further embodiment, the notification manager 200 provides a user interface in which a user may customise the manner in which the notification manager 200 operates. For example, the user may specify the maximum number of icons permitted in a notification manager view or page. Alternatively, the user may specify the minimum and/or maximum sizes for an icon.

The aforementioned embodiments have been described with reference to certain arrangements of hardware and software. The invention is not however limited in this respect and it is known to provide certain components described above as hardware components instead as software components in alternate embodiments. Similarly, components described above as software may instead be provided as hardware such as, for example, application specific integrated chips.

What we claim is:

1. Apparatus comprising a notification manager and a display, said notification manager being configured to:
designate a notification display area for simultaneously displaying a plurality of notifications on said display,
in a foreground mode display said notification display area and in a background mode hide said notification display area, and
display a notification temporarily on a portion of said display when in said background mode, said portion of said display not being reserved for the display of notifications during operation of said display.

2. The apparatus according claim 1 wherein said notification manager is configured to display a prompt when a notification occurs when said notification manager is in said background mode.

3. The apparatus according to claim 2 wherein said notification manager is configured to display said prompt when a first notification occurs after said notification manager is switched from said foreground mode to said background mode.

4. The apparatus according to claim 3 wherein said prompt comprises an icon and said icon is visible on said display when said notification manager is in said background mode.

5. The apparatus according to claim 1 wherein said notification manager is configured to suppress display of one or more selected notifications.

6. The apparatus according to claim 5 wherein said notification manager is configured to select said one or more selected notifications according to one or more user specified criteria or one or more system criteria.

7. The apparatus according to claim 1 wherein said notification manager is configured to distinguish between notifications previously displayed and new notifications.

8. The apparatus according to claim 1 wherein said notification manager is configured to bring a corresponding application to a foreground mode, or to launch said corresponding application, on user interaction with a notification.

9. The apparatus according to claim 8 wherein said user interaction comprises a user selecting said notification.

10. The apparatus according to claim 1 wherein said notification manager is configured to group a plurality of notifications and wherein said notifications are grouped according to application or according to notification type.

11. The apparatus according to claim 1 wherein said notification manager is configured to display a notification having an associated application in said notification display area and a notification not having an associated application in a second area, and display notifications relating to one or more system events in said second area.

12. A method comprising having a notification manager configure a notification display area to simultaneously display a plurality of notifications on a display, displaying said notification display area on said display when said notification manager is in a foreground mode, not displaying said notification display area on said display when said notification manager is in a background mode, said method further comprising displaying a notification temporarily on a portion of said display when said notification manager is in said background mode, said portion of said display not being reserved for the display of notifications during operation of said display.

13. The method according to claim 12 comprising displaying a prompt when a notification occurs when said notification manager is in said background mode.

14. The method according to claim 13 wherein said prompt is displayed when a first notification occurs after said notification display area is switched from said foreground mode to said background mode.

15. The method according to claim 14 wherein said prompt comprises an icon, said icon being visible on said display when said notification manager is in said background mode.

16. The method according to claim 12 comprising suppressing display of one or more selected notifications.

17. The method according to claim 16 wherein said one or more selected notifications are selected according to one or more user specified criteria or one or more system criteria.

18. The method according to claim 17 further comprising distinguishing between notifications previously displayed and new notifications.

19. The method according to claim 12 further comprising bringing a corresponding application to a foreground mode or launching said corresponding application, on interaction with a notification.

20. The method according to claim 19 wherein said interaction comprises a user selecting said application notification.

21. The method according to claim 12 further comprising grouping a plurality of notifications and wherein said notifications are grouped according to application or according to notification type.

22. The method according to claims 12 further comprising displaying a notification having an application associated therewith in said notification display area, displaying a notification not having an application associated therewith in a second area, and displaying notifications relating to one of more system events in said second area.

23. A memory medium storing a computer program executable by a processor of a computing device, said computing device having a notification manager and a display, said computer program performing operations when executed by said processor, said operations comprising:
having a notification manager configure a notification display area to simultaneously display a plurality of notifications on a display;
displaying said notification display area on said display when said notification manager is in a foreground mode;
not displaying said notification display area on said display when said notification manager is in a background mode;
said operations further comprising displaying a notification temporarily on a portion of said display when said notification manager is in said background mode, said portion of said display not being reserved for the display of notifications during operation of said display.
